(19) United States
(12) Patent Application Publication
(10) Pub. No.: US 2017/0290428 A1
(43) Pub. Date: Oct. 12, 2017

(54) SHELF PRODUCT

(71) Applicant: Creative Plastic Concepts, LLC, Sycamore, OH (US)

(72) Inventor: Nickolas Reinhart, Findlay, OH (US)

(21) Appl. No.: 15/484,423

(22) Filed: Apr. 11, 2017

Related U.S. Application Data
(60) Provisional application No. 62/320,749, filed on Apr. 11, 2016.

(51) Int. Cl. A47B 96/02; B29C 45/00; B29C 45/14; A47B 47/00

(52) U.S. Cl. CPC A47B 96/021; A47B 47/0083; B29C 45/0001; B29C 45/14; B29K 2711/14

(57) ABSTRACT

A shelf includes a main body with a plurality of support features formed therein. In one embodiment, each of the support features formed in the main body may include a board having an overmolded exterior. The board may have a plurality of apertures formed therethrough. The overmolded exterior extends through the apertures formed in the board. In another embodiment, each of the support features includes a removable board in an elongate recess that is secured in place by a cover. The boards may be wooden and add a desired strength and rigidity to the main body.

### CROSS-REFERENCE TO RELATED APPLICATIONS

This application claims the benefit of U.S. Provisional Application No. 62/320,749, filed on Apr. 11, 2016. The entire disclosure of the above application is hereby incorporated herein by reference.

### FIELD

The disclosure generally relates to a shelf and, more particularly, to a shelf with wooden board supports.

### BACKGROUND

Shelving systems, such as modular shelving systems, are known for storing and supporting items of all types. Typically, shelving systems contain several components that can be easily assembled to conform to a customer's needs. The shelving systems can include shelves, support posts, and connectors, for example.

It is desirable for each shelf to be formed from a lightweight material such as plastic to facilitate portability and ease of assembly of the shelving system. Many plastic shelving systems are shown in the prior art, including plastic shelving systems that fit together and assemble. For example, U.S. Pat. No. 4,706,576 to Barry James shows a rectangular shelving system capable of assembly into multiple configurations. Although plastic shelving systems are often lighter and more convenient to assemble than conventional shelving, plastic shelving systems often lack the same rigidity and strength as conventional shelving.

There is a continuing need for a shelf or shelving system that is lightweight. Desirably, the shelf also minimizes manufacturing costs and complexity of assembly while maximizing a strength and stiffness thereof.

### SUMMARY

In concordance with the instant disclosure, a shelf that is lightweight, minimizes manufacturing costs and complexity of assembly, and maximizes the strength and stiffness thereof, has surprisingly been discovered.

In one embodiment, a shelf includes a main body and a plurality of support features. The support features are formed in the main body. Each of the support features include a board having an overmolded exterior. The shelf capable of standing on its own, or connected to a shelving structure.

In a further embodiment, a shelf includes a main body and a plurality of support features. The support features are formed in the main body. Each of the support features includes a board, wherein the board contains a plurality of apertures. The board has an overmolded exterior extending through the apertures. The shelf capable of standing on its own, or connected to a shelving structure.

In another embodiment, a shelf includes a main body and a plurality of support features disposed on the main body. Each of the support features includes a recess formed in the main body. A removable board is received within the recess. An insert is coupled to the main body and maintains the board within the recess. The shelf capable of standing on its own, or connected to a shelving structure.

### DRAWINGS

The above, as well as other advantages of the present disclosure, will become readily apparent to those skilled in the art from the following detailed description, particularly when considered in the light of the drawings described hereafter.

FIG. 1 is a top perspective view of a shelf according to one embodiment of the present disclosure;

FIG. 2 is a bottom perspective view of the shelf shown in FIG. 1

FIG. 3 is a fragmentary cross-sectional top perspective view of the shelf shown in FIG. 1, and taken along the section line 3--3;

FIG. 4 is a top perspective view of a wooden board support with apertures that is employed with the shelf shown in FIGS. 1-3;

FIG. 5 is a fragmentary cross-sectional side elevational view of the shelf shown in FIG. 1-3, and taken along section line 5--5 in FIG. 3;

FIG. 6 is a top perspective view of a shelf according to another embodiment of the present disclosure, a main body of the shelf having recesses for receiving wooden board supports, openings to optimize material usage, and apertures for receiving tabs of a cover;

FIG. 7 is a top perspective view of a shelf according to a further embodiment of the present disclosure, a main body of the shelf having recesses and apertures for receiving tabs of a cover;

FIG. 8 is a bottom perspective view of a shelf shown in FIG. 7;

FIG. 9 is a top perspective view of a shelf as shown in FIGS. 6-8 with wooden board supports inserted into the recesses;

FIG. 10 is a bottom perspective view of a cover for use with the shelf shown in FIGS. 6-9;

FIG. 11 is a top perspective view of the shelf as shown in FIGS. 6-9 with the cover of FIG. 10 affixed to each of the recesses; and

FIG. 12 shows an enlarged top perspective cross-sectional view of inserts and boards cooperating with a main body of the shelf taken along the section line 12-12 in FIG. 11.

### DETAILED DESCRIPTION

The following description is merely exemplary in nature and is not intended to limit the present disclosure, application, or uses. It should also be understood that throughout the drawings, corresponding reference numerals indicate like or corresponding parts and features. In respect of the methods disclosed, the order of the steps presented is exemplary in nature, and thus, is not necessary or critical.

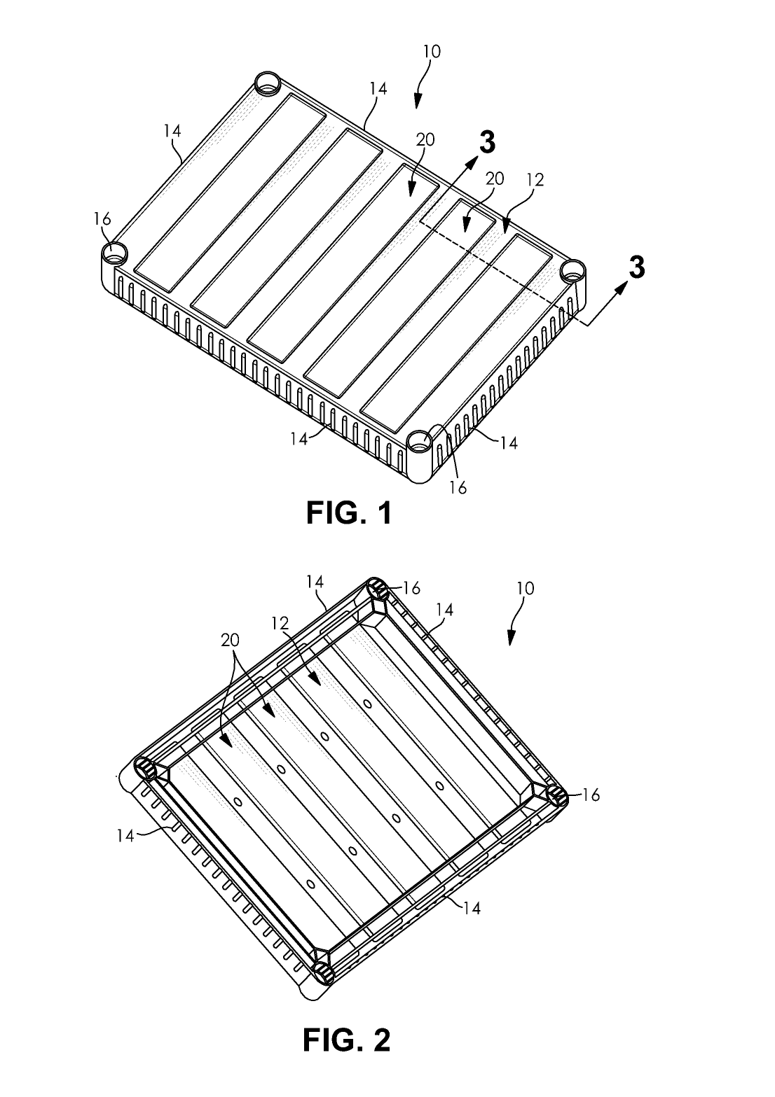

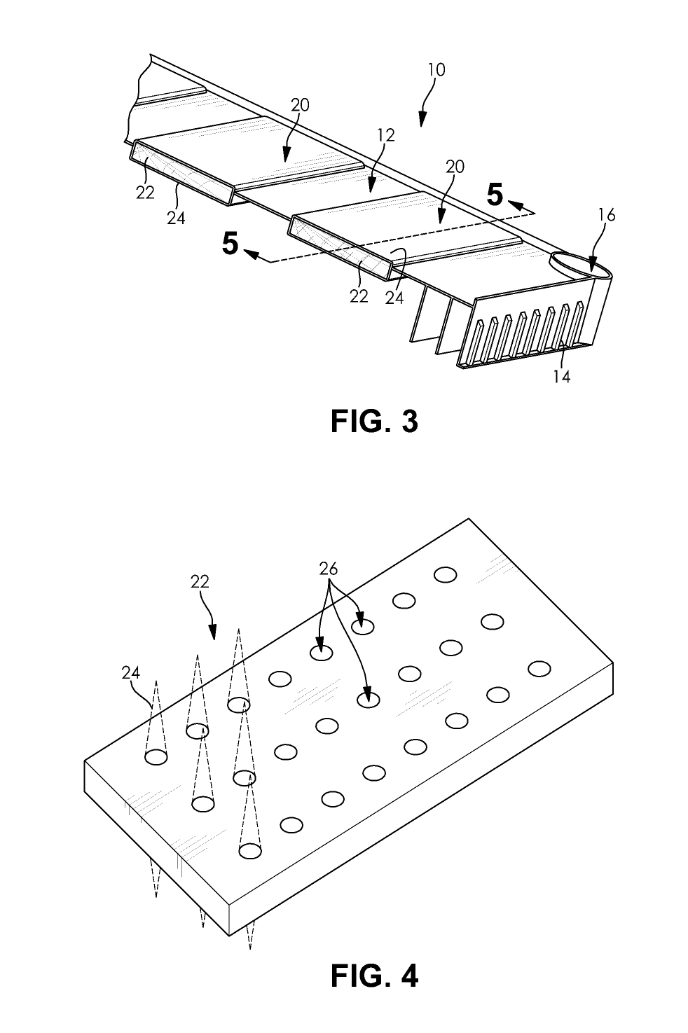

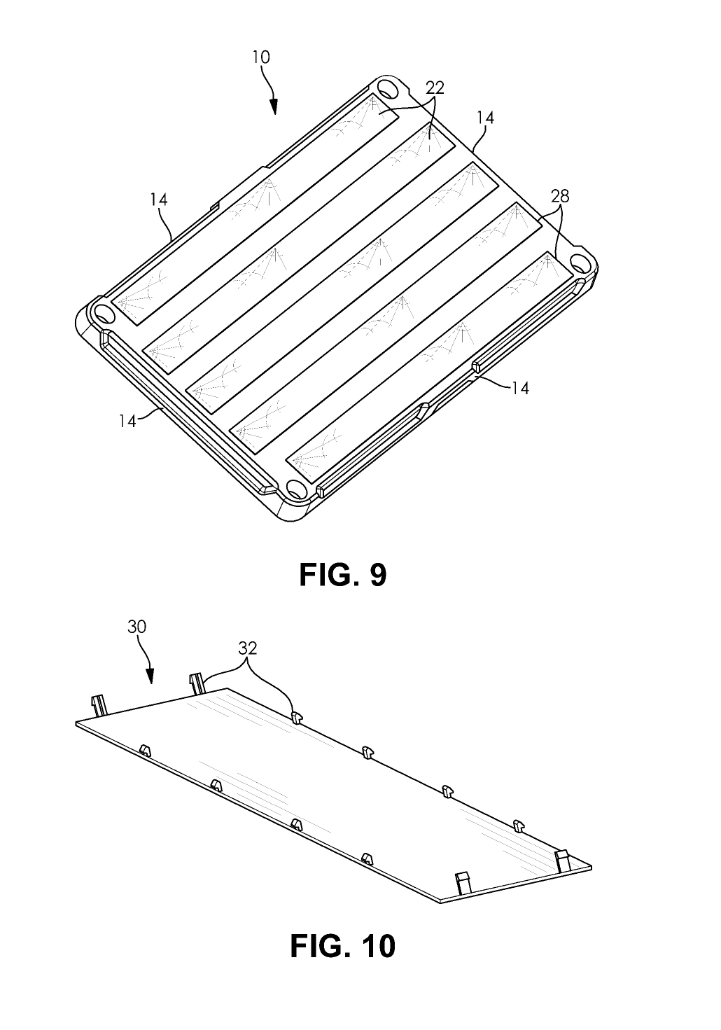

FIGS. 1-12 illustrate a shelf 10 according various embodiments of the present disclosure. The shelf 10 can be employed as a modular shelf for use in a modular shelving system, for example. The shelf 10 may cooperate with other components such as support posts to form the modular shelving system. However, it is understood the shelf 10 can be employed as a standalone platform or crate unit. All dimensions and materials identified are merely illustrative in nature, and should not be considered limiting unless otherwise disclosed.

The shelf 10 includes a main body 12 having walls 14. The walls 14 are integrally formed with the main body 12 and extend therefrom. In the embodiments shown, the main body 12 is substantially rectangular and has four corners. Other shapes for the shelf 10 may also be selected by a skilled artisan within the scope of the present disclosure.

The main body 12 includes corner openings 16. The corner openings 16 are formed therein for receiving posts or supports, and for facilitating stacking of the shelf 10. While four openings 16 are illustrated, more than four or less than four corner openings 16 can be contemplated for use, depending on the overall shape of the main body 12 selected.

The main body 12 is formed from a lightweight plastic material such as a polypropylene plastic material, by a molding process such as injection molding, as nonlimiting examples. It should be understood, the shelf 10 can be formed from any suitable material, including other thermoplastic materials such as polyethylene, for example, and non-thermoplastic materials such as foam or metal, for example. Any suitable processes for forming the shelf 10 may also be employed, as desired.

With further reference to FIGS. 1-12, the shelf 10 includes support features 20 disposed within the main body 12. The support features 20 extend substantially parallel to each other along a width of the main body 12 (as shown in FIGS. 1-3) or along a length of the main body 12 (as shown in FIGS. 6-9 and 11-12). Five support features 20 are illustrated in the embodiment shown. However, it should be appreciated that more or fewer than five support features 20 can be employed, as desired.

In the embodiment illustrated in FIGS. 1-5, each of the support features 20 include a board 22. The board 22 is a wood board such as plywood, hardwood board, or medium density board, as non-limiting examples. However, other materials for the board 22 may be selected by a skilled artisan within the scope of the present disclosure.

The board 22 may have an overmolded exterior 24. The overmolded exterior 24 is a plastic exterior that is molded over the board 22 by an overmolding process. The overmolded exterior 24 can be formed by other materials, as desired. The overmolded exterior 24 of each of the support features 20 may be integrally formed with the main body 12 in an overmolding operation. For example, the board 22 can be positioned in a mold for forming the main body 12. The molding material, such as a thermoplastic, is then used with the mold to form both the main body 12 and the overmolded exterior 24, over the board 22. The shelf 10 is thereby provided as an integral unit.

In another embodiment, the overmolded support features 20 can be formed separately from the main body 12, through a separate injection molding process, and subsequently coupled thereto with mechanical or adhesive fasteners.

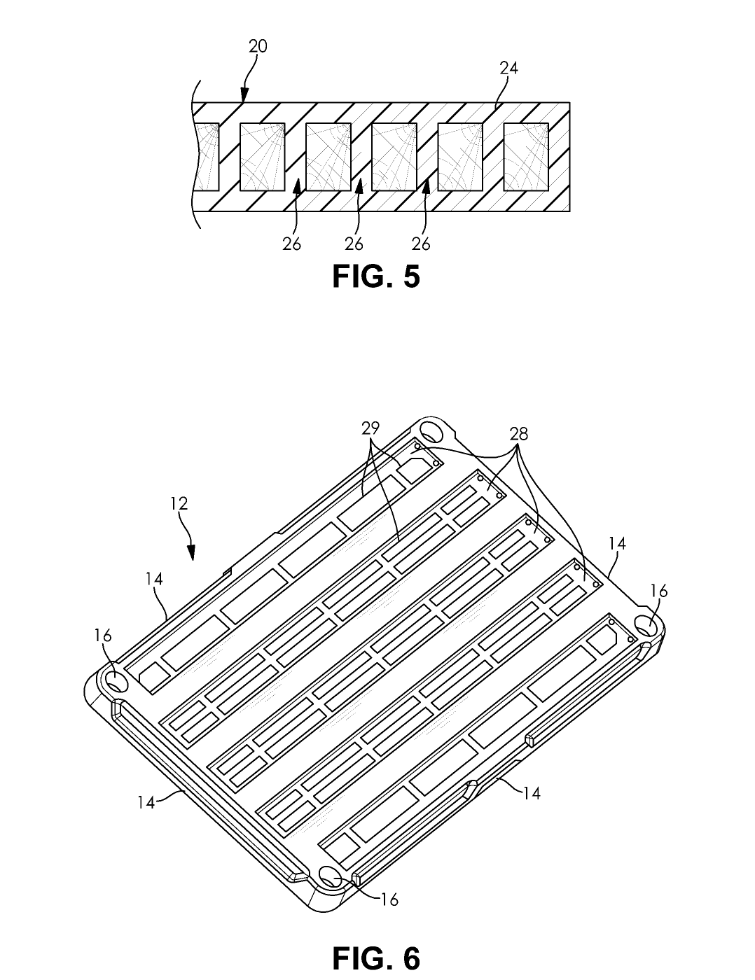

As illustrated in FIGS. 4 and 5, in certain embodiments the board 22 may include a plurality of apertures 26 formed therein. The apertures 26 can be formed by a punch-press or a drill press, for example, prior to the overmolding operation. During the overmolding operation, the overmolded exterior 24 extends through the apertures 26 between opposing surfaces of the board 22. Accordingly, the overmolded exterior 24 formed on one surface of the board 22 is continuous with the overmolded exterior 24 formed on the opposing surface of the board 22 through the apertures 26. The strength and integration of the board 22 with the remainder of the shelf 10 is thereby facilitated.

As shown in FIG. 4, the apertures 26 may be formed in a grid arrangement on the board 22. However, it should be understood that any number of apertures 26 can be formed in the board 22 to facilitate the increase in strength, as desired.

To assemble and form the shelf 10, the boards 20 are positioned in the mold for forming the main body 12. The apertures 26 can be pre-formed into the board 22 prior to positioning the boards 22 in the mold. A molding material, such as thermoplastic, is then disposed or injected into the mold. The overmolded exterior 24 is formed by the molding material flowing over the boards 22, and in certain embodiments through the apertures 26 of the boards 22, during the overmolding process.

Advantageously, the support features 20 including the board 22 maximize an overall strength, stiffness, and rigidity of the shelf 10, while maintaining a lightweight shelf 10.

It should be appreciated that the apertures 26 formed in the board 22 can also be employed to guide locating pins of the mold therein. The apertures 26 used to guide the locating pins of the mold facilitate proper positioning of the boards 22 within the mold. The overmolded exterior 24 extending through the apertures 26 further maximizes an overall strength, stiffness, and rigidity of the shelf 10.

FIGS. 6-12 show the shelf 10 according to further embodiments of the present disclosure. It should be appreciated that the recessed and covered embodiments of FIGS. 6-12 may be employed separately, or together with, the overmolded embodiments of FIGS. 1-5, and the shelf 10 may include both sets of features, as desired.

In these further embodiments, the support features 20 of the shelf 10 include elongate recesses 28 that are formed in the main body 12. The shape of each of the recesses 28 corresponds in shape to one of the boards 22. In operation, the recesses 28 receive the boards 22.

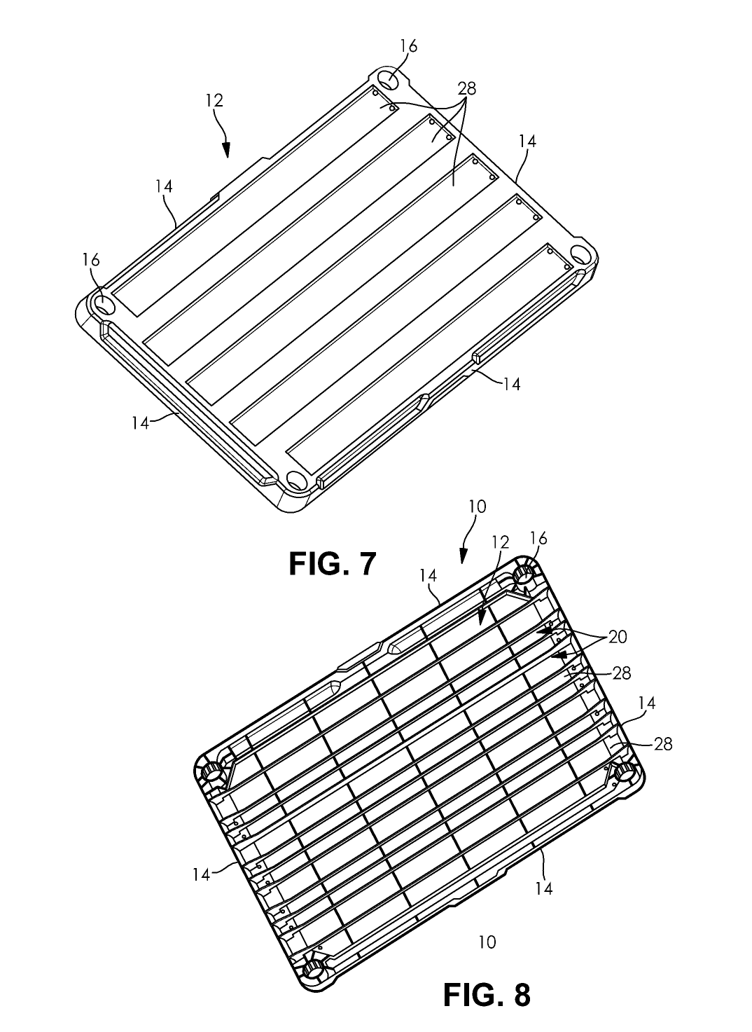

As illustrated in FIG. 6, additional holes or openings 29 can be formed in the recesses 28. The use of the additional openings 29 to minimize a cost to manufacture the shelf 10 and minimize an overall weight of the shelf 10. However, the recesses 28 can also be formed without the openings 29, as illustrated in FIG. 7.

With renewed reference to FIGS. 6-12, each of the support features 20 further include an insert 30. The insert 30 is positioned over the board 22 and received by the recess 28. The insert 30 is coupled to the main body 12 to maintain and secure the board 22 within the recess 28.

In particular examples, an outer surface of the insert is substantially flush with the outer surface of the remainder of the main body 12, to thereby create a uniform outer surface of the resulting shelf 10. In these examples, a depth of each of the elongate recesses 28 may be greater than a height of each of the boards 22 disposed within the recesses 28 by a dimension equivalent to a thickness of the insert 30. It should be understood that such dimensions advantageously result in an abutting of the boards 22 to both the bottom of the recesses 28 and the underside of the inserts 30, without the forming of any gaps therebetween.

In certain embodiments, shown in FIG. 10, the insert 30 can include a plurality of tabs 32 formed adjacent a perimeter of the insert 30. The tabs 32 are configured to engage with an inner lip 34 formed on the main body 12, as shown in FIG. 12. For example, each of the tabs 32 may have a hooked end that catches an edge of the inner lip 34. The inner lip 34 may circumscribe the recess 28, or may be defined by the openings 29 formed in the recess 28, as non-limiting examples.

In other embodiments, the insert 30 can be coupled to the main body 12 by other suitable means such as a welding, friction welding, press fitting the inserts 30 with the main body 12, or by employing mechanical coupling devices such as screws, nails, pins, and the like. The use of chemical adhesives to couple the insert 30 to the main body 12, and thereby secure the support 20 within the recess 28, is also contemplated and within the scope of the present disclosure.

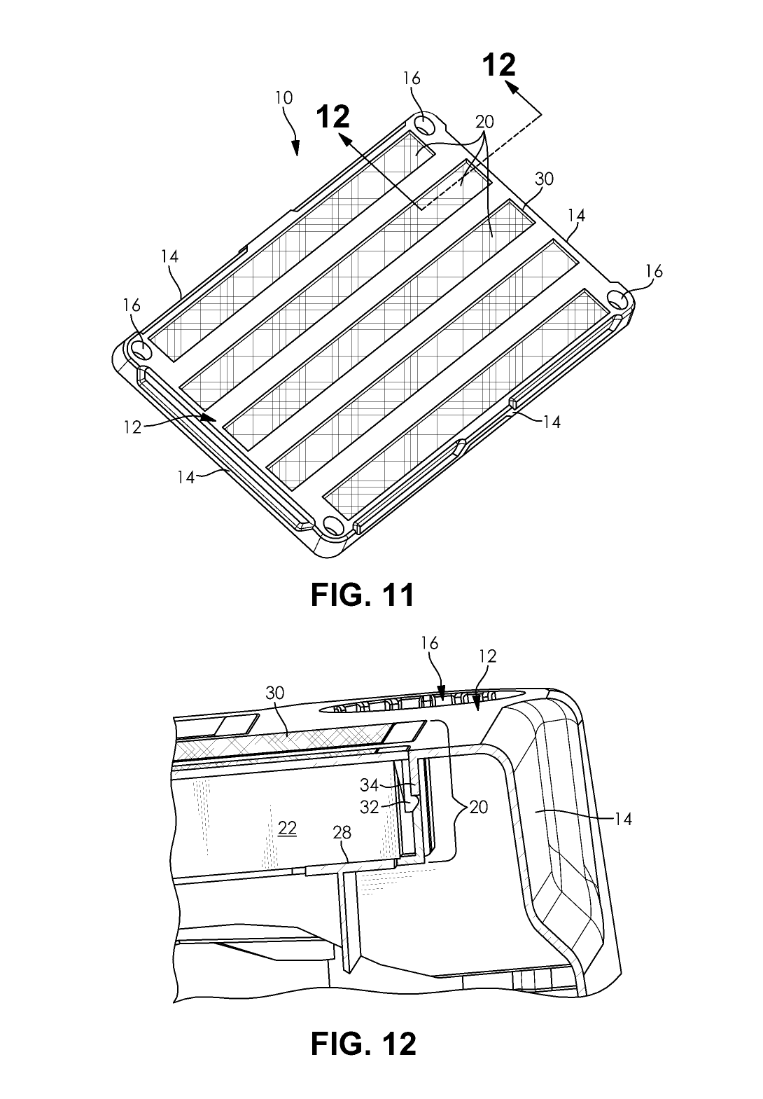

As shown in FIGS. 11-12, each of the inserts 30 of the support features 20 can include surface features formed on an outer surface thereof. For example, the surface features can include a texturing or embossed pattern formed on the outer surface of the inserts 30. The surface features militate against slippage or movement of items or products stored on the shelf 10.

To assemble and form the shelf 10 illustrated in FIGS. 6-12, the main body 12 is formed by molding or other suitable process. The main body 12 is formed with the elongate recesses 28 therein. The boards 22 are inserted into and received by the recesses 28. The inserts 30 are then coupled to the main body 12 to cover the boards 22 and recesses 28.

Advantageously, the boards 22 add a strength, rigidity, and stiffness to the shelf 10. It is understood that the boards 22 can also be removed from the shelf 10 to minimize an overall weight of the shelf 10, for example, during storage and shipping of the shelf 10, as desired.

While certain representative embodiments and details have been shown for purposes of illustrating the invention, it will be apparent to those skilled in the art that various changes may be made without departing from the scope of the disclosure, which is further described in the following appended claims.

What is claimed is:

1. A shelf, comprising:
a main body having a plurality of support features formed therein, each of the support features including a board having one of a) an overmolded exterior, and b) an insert positioned over the board, the board disposed in an elongate recess formed in the main body.

2. The shelf of claim 1, wherein the main body is rectangular and has four openings configured to receive a support post.

3. The shelf of claim 1, wherein the support features extend substantially parallel to each other along the length of the main body.

4. The shelf of claim 1, wherein the main body is formed from a thermoplastic material and the board is wooden.

5. The shelf of claim 4, wherein the support features include the board having the overmolded exterior, and the board has a plurality of apertures formed therethrough, the thermoplastic of the main body disposed through the apertures.

6. The shelf of claim 5, wherein the apertures are arranged in a grid across the board.

7. The shelf of claim 5, wherein the support features include a plurality of the boards having the overmolded exterior spaced apart along one of a length and a width of the main body.

8. The shelf of claim 1, wherein the support features include the insert positioned over the board, and the insert has a plurality of tabs that couple the insert to the main body.

9. The shelf of claim 8, wherein the tabs engage with an inner lip formed within the elongate recess.

10. The shelf of claim 9, wherein the insert has an outer surface with one of a texture and an embossed design to militate against a slippage of items positioned on the main body.

11. A shelf, comprising:
a main body having a plurality of support features formed therein, each of the support features including a board having an overmolded exterior.

12. The shelf of claim 11, wherein the main body is formed from a thermoplastic material and the board is wooden.

13. The shelf of claim 12, wherein the support features include the board having the overmolded exterior, and the board has a plurality of apertures formed therethrough, the thermoplastic of the main body disposed through the apertures.

14. The shelf of claim 13, wherein the apertures are arranged in a grid across the board.

15. The shelf of claim 13, wherein the support features include a plurality of the boards having the overmolded exterior spaced apart along one of a length and a width of the main body.

16. A shelf, comprising:
a main body having a plurality of support features formed therein, each of the support features including a board with an insert positioned over the board, the board disposed in an elongate recess formed in the main body.

17. The shelf of claim 16, wherein the main body is formed from a thermoplastic material and the board is wooden.

18. The shelf of claim 17, wherein the support features include the insert positioned over the board, and the insert has a plurality of tabs that couple the insert to the main body.

19. The shelf of claim 18, wherein the tabs engage with an inner lip formed within the elongate recess.

20. The shelf of claim 18, wherein the insert has an outer surface with one of a texture and an embossed design to militate against a slippage of items positioned on the main body.
